(19) United States
(12) Patent Application Publication
(10) Pub. No.: US 2026/0228518 A1
(43) Pub. Date: Aug. 6, 2026

(54) AUTOMATED ADAPTIVE CONTENT GENERATION WITH SELF-REFINEMENT

(71) Applicant: Walmart Apollo, LLC, Bentonville, AR (US)

(72) Inventors: Varun A. Vasudevan, Palo Alto, CA (US); Abhinav Prakash, Milpitas, CA (US); Faezeh Akhavizadegan, Mountain View, CA (US); Yokila Arora, San Jose, CA (US); Hyun Duk Cho, San Francisco, CA (US); Sushant Kumar, San Jose, CA (US); Kannan Achan, Saratoga, CA (US)

(21) Appl. No.: 19/043,032

(22) Filed: Jan. 31, 2025

(51) Int. Cl. G06N 3/08

(52) U.S. Cl. CPC G06N 3/08

(57) ABSTRACT

The disclosure herein describes context-based candidate data generation with self-refinement. An example disclosed operation includes: generating a batch of candidate data using a large language model (LLM) based generator, formatting the batch of candidate data according to a plurality of formatting constraints, evaluating, using a sequence of evaluators, a candidate of the batch of candidate data, determining whether any evaluator of the sequence of evaluators fails the candidate, based on determining that at least one evaluator of the sequence of evaluators fails the candidate, identifying a first failing evaluator, mapping an output of the first failing evaluator to a refiner instruction, refining, using a LLM based refiner, the candidate based on the refiner instruction, reformatting the refined candidate, and re-evaluating the refined candidate, until earlier of either a maximum of refine attempts is reached or all evaluators of the sequence of evaluators are successful.

### BACKGROUND

Generative large language models (LLMs) are used frequently across various domains. The ability to understand and generate natural language has made them useful and efficient in various industries. However, as LLMs grow in size and complexity, efficiently scaling LLMs for practical applications has become more challenging. Additionally, accurately assessing the performance of LLMs is a complex task, because it is difficult to assess nuances of the language generated by LLMs.

### SUMMARY

Some embodiments provide a system and method for automatic content generation with self-refinement. The system generates a batch of candidate data using a large language model (LLM) based generator. The batch of candidate data are formatted according to a plurality of formatting constraints. The system evaluates, using a sequence of evaluators, a candidate of the batch of candidate data. The system determines whether any evaluator of the sequence of evaluators fails the candidate and based on determining that at least one evaluator of the sequence of evaluators fails the candidate, identifies a first failing evaluator of the sequence of evaluators. An output of the first failing evaluator is mapped to a refiner instruction. The candidate is refined, using a LLM based refiner, based on the refiner instruction. The refined candidate is reformatted and re-evaluated, using the sequence of evaluators, until earlier of either a maximum of refine attempts is reached or all evaluators of the sequence of evaluators are successful.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 illustrates an example arrangement that advantageously provides automated adaptive data generation with self-refinement.

FIG. 2 illustrates further details regarding a content generator for automated adaptive data generation with self-refinement.

FIG. 3 illustrates a set of prompts for a large language model (LLM)-based chat model.

FIG. 4 illustrates examples of various types of evaluators for evaluating candidate content.

FIG. 5 illustrates further detail regarding operations of the evaluators.

FIG. 6 illustrates detail regarding automatic generation and recursive refinement of candidate content, as may be performed using the arrangement of FIG. 1.

FIG. 7 illustrates automatically applying a given guideline to evaluate a generated candidate content.

FIG. 8 depicts a flow chart illustrating operations that may be performed using the arrangement of FIG. 1.

FIG. 9 depicts a flow chart illustrating operations of applying a given guideline to evaluate a generated candidate content.

FIG. 10 depicts a table illustrating a candidate content during generation, evaluation, and refinement process.

Corresponding reference characters indicate corresponding parts throughout the drawings.

### DETAILED DESCRIPTION

A more detailed understanding can be obtained from the following descriptions, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that can in isolation and out of context be read as absolute and therefore limiting, can only properly be read as being constructively preceded by a clause such as “In at least some examples, . . . ” For brevity and clarity of presentation, this implied leading clause is not repeated ad nauseum.

Aspects of disclosure provide context-based automated content generation, where contents are generated based on context of a generation task using generative LLMs.

Applications of generative LLMs have expanded rapidly with significant advancement in natural language processing and generation. LLMs are leveraged across a wide range of industries to enhance efficiency. LLMs, using deep learning architectures, can understand, generate, and manipulate natural human language. LLMs automate various tasks, reducing the workload of human agents and speeding up the tasks. However, generative LLMs face several challenges that impact their development. As LLMs grow in size and complexity, scalability has become a significant challenge for LLMs. The cost and computational resources to train and manage LLMs have increased, requiring careful planning and on-going maintenance. Additionally, accurately assessing the performance of LLMs is a complex and resource-intensive task. Traditional evaluation metrics, such as accuracy, often fall short in capturing the nuances of the language generation.

For tasks that require maintaining consistency and adhering to requirements, the conventional free-form content generation using LLMs may not be suitable. Artificial intelligence (AI) models for free-form text generation might struggle with understanding nuanced context or maintaining coherence. Furthermore, the conventional free-form text generation does not consider constraints that are applicable to generating content, such as character limits, formatting requirements, internal policies, and/or regulatory compliance. Additionally, the conventional free-form text generation does not work well with generating contents that are coherent and controlled.

Alternatively, constrained LLMs can generate contents according to specific rules or constraints more effectively and efficiently. However, the conventional constrained LLMs do not provide an end-to-end generation that can handle different use cases of varying complexity. Moreover, the conventional method requires detailed specification of constraints that guide the generation process. LLMs struggle with planning tasks because LLMs lack the ability to dynamically adapt to new information and changing guidelines. Therefore, the conventional method usually requires deliberative manual specification in planning, which can be difficult and time-consuming. Accordingly, the conventional constrained LLMs face challenges when it comes to scaling up.

Constrained LLMs also face challenges because LLMs have limited ability to consistently attend to each specified instruction with equal importance. The effectiveness of a LLM in following instructions can vary based on the nature of instructions given to the LLM. While LLMs are designed to process and generate text based on given instructions, if multiple instructions are provided, especially if the instructions are complex or conflicting, LLMs may prioritize some over others based on patterns learned during training. Accordingly, LLMs may not attend to each instruction with equal importance on the first attempt. The conventional constrained LLMs requires manual adjustment or correction to ensure that the generated content adhere to the instructions.

While LLMs can be fine-tuned or tailored to specific tasks or domains and adapt to new information and evolving requirement, fine-tuning LLMs may not be practical. Fine-tuning LLMs require significant computational power and can be resource-intensive and costly. Moreover, effective fine-tuning demands large, high-quality datasets that are relevant to the specific task. However, it is challenging to gather and curate such datasets for adaptive content generating tasks due to changes in language and requirements. Additionally, LLMs need regular updates to stay relevant, especially in dynamic fields such as online content generation, and the on-going maintenance adds to the complexity and cost. Fine-tuning LLMs is also inefficient because it is not scalable to multiple specific tasks.

Aspects of the disclosure can improve the operations of generative AI systems at least by enabling automated constrained content generation using LLM-based iterative refinement. For example, aspects of the disclosure may enable generating contents in a controlled and precise manner bound by rules and guidelines. Aspects of the disclosure can overcome the challenges of constrained LLMs in an unconventional way by using novel LLM-driven iterative evaluation-refinement techniques. Aspects of the disclosure can also overcome the challenges of free-form text generation by generating content that adheres to guidelines and constraints using the LLM-based evaluators and refiner. Aspects of the disclosure can automatically generate prompts for generative LLMs based on context, which may be useful for reducing or eliminating the burden of manually specifying the constraints for tasks, thereby enhancing efficiency in content generation and enabling scalability across multiple tasks. Aspects of the disclosure provide an end-to-end content generation system, which includes a sequence of evaluators and a LLM-based refiner that enable iterative self-refinement. Using the sequence of evaluators and the refiner, the generated contents are recursively evaluated and refined to adhere to the constraints and guidelines. By recursively refining the generated contents to adhere to guidelines, aspects of the disclosure may improve the quality of assessing the performance of LLMs. Additionally, the recursive refining may eliminate or reduce the need to fine-tune LLMs for the specific tasks, thereby conserving computer resources and reducing cost. Therefore, aspects of the disclosure can enable scalable automatic content generation using LLMs.

Aspects of the disclosure can provide an end-to-end system that can handle different use cases of varying complexity. The generated content can meet specified formats and display requirements by automatically creating prompts for LLM-based generators. The automatic prompt creation can be achieved by contextually retrieving constraints to create the prompts for LLMs. The prompts, which may include high-level objectives of the specific task, are provided to LLMs to perform the specific generation task. The structure and format of the generation results are automatically specified by contextually retrieving relevant constraints from a pool of constraints. Aspects of the disclosure may be useful for improving the operations of generative LLMs by enabling automatic creation of prompts based on given contexts. Additionally, by learning from past tasks and generating prompts based on the learned context, aspects of the disclosure may improve the efficiency and scalability of LLMs. In addition, aspects of the disclosure may enable LLMs to apply more nuanced and subjective constraints. LLMs can reduce bias by being instructed to avoid specific words or sentiments. Aspects of the disclosure may enable LLMs to receive these nuanced and subjective constraints as prompts, which are contextually retrieved and automatically generated based on given context. Thus, aspects of the disclosure may enhance computer capability by improving performance of LLMs and alleviating the burdens of manually generating prompts.

Aspects of the disclosure use an innovative method to provide that the constraints are met through a recursive loop of evaluation and refinement. The improved evaluation methods can measure how well the subjective constraints are met by selecting and designing the sequence of evaluators and using the reasoning capability of LLMs. The LLM-based evaluators can determine the nuanced sentiment and tone of generated content and assess whether the determined sentiment is suitable for the given context and constraints. Furthermore, aspects of the disclosure may refine the generated content to adjust the sentiment and the tone of the content when the sentiment of the generated content is determined unsuitable or undesirable. The evaluation and refinement process can be automated by employing LLM-based evaluators, and automatically adjust subjective and nuanced sentiments of the generated content by transforming the decision and explanation from the LLM-based evaluator to an instruction for the refiner. The LLM-based evaluator may significantly reduce the need for human intervention in the generation process by automating the evaluation and refinement of tone and nuance. Aspects of the disclosure provide for consistency and quality of the generated contents, making the entire process more efficient and scalable.

For example, the LLM-driven iterative evaluation-refinement techniques can be applied to generate variations of advertisement texts in large quantity in a relatively short amount of time. Online platforms strive to provide interesting digital content for users to attract attention and generate interest. However, providing content that is relevant to each user while adhering to internal and external requirements can be challenging. Capturing and maintaining user attention in a crowded digital space requires creative and compelling content. At the same time, digital content may be subject to formatting and display requirements.

Aspects of the disclosure, applied to advertisement texts in this example, can generate a variety of targeted advertisement texts while adhering to requirements and constraints. The variations of advertisement texts are generated based on contexts, such as personal preference, user persona, user lifestyle, and/or different settings such as time of the year (e.g., season, holiday, etc.). The generated and approved advertisement texts are stored in a datastore according to the contexts and cohorts. The stored texts may be dynamically displayed to users as they browse or interact with a website or an application. This dynamic display of advertisement texts can be tailored to each user based on their individual preference and behaviors. For example, if a user shows interest in specific topics, a stored copy that aligns with the user's interest will be dynamically selected and displayed. This way, the user or the viewer of the website sees the advertisement texts that fit their interest and preference in real-time, while the advertisement texts maintain the suitable tones and sentiments fit for the user. This personalized approach may be useful in enhancing the user experience and is likely to engage the user.

In another example, aspects of the disclosure can enhance the performance of virtual AI assistants by generating controlled and refined responses. By using the LLM-driven iterative evaluation-refinement techniques to evaluate a response, aspects of the disclosure may generate responses that are more accurate and relevant to the user's query. Additionally, the LLM-based communication evaluator may provide that the tone and style of the responses are consistent, enabling the virtual AI assistant to adhere to specific guidelines. Furthermore, aspects of the disclosure can consider user-specific constraints based on context or user preference, generating more personalized responses and creating a coherent user experience.

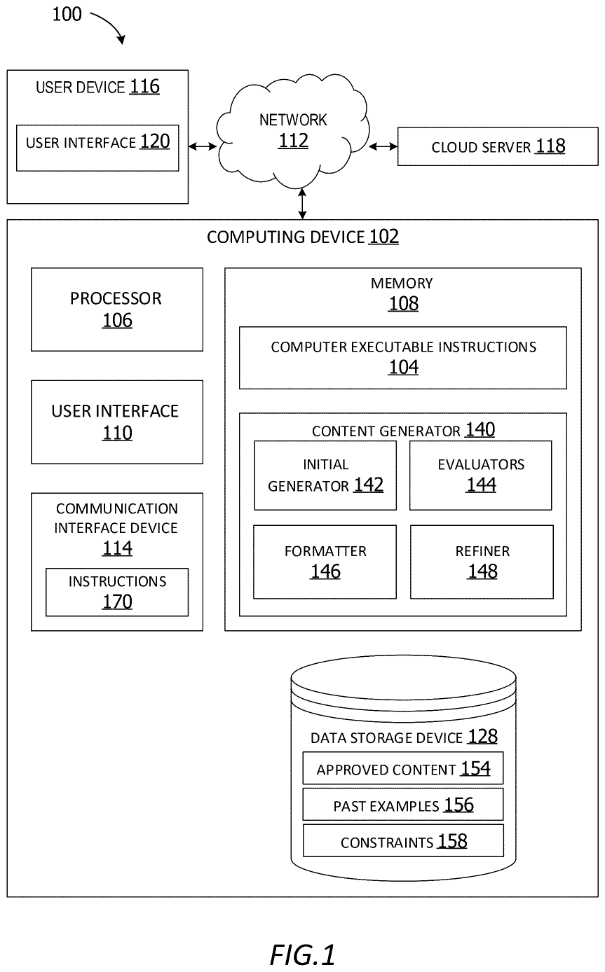

Referring to FIG. 1, an example arrangement illustrates a system 100 for automatic content generation with self-refinement. In the example of FIG. 1, the computing device 102 represents any device executing computer-executable instructions 104 (e.g., as application programs, operating system functionality, or both) to implement the operations and functionality associated with the computing device 102. The computing device 102, in some examples, includes a mobile computing device or any other portable device. A mobile computing device includes, for example but without limitation, a mobile telephone, laptop, tablet, computing pad, netbook, gaming device, wearable device, and/or portable media player. The computing device 102 can also include less-portable devices such as servers, desktop personal computers, kiosks, or tabletop devices. Additionally, the computing device 102 can represent a group of processing units or other computing devices.

In some examples, the computing device 102 has at least one processor 106 and a memory 108. The computing device 102, in other examples, includes a user interface 110.

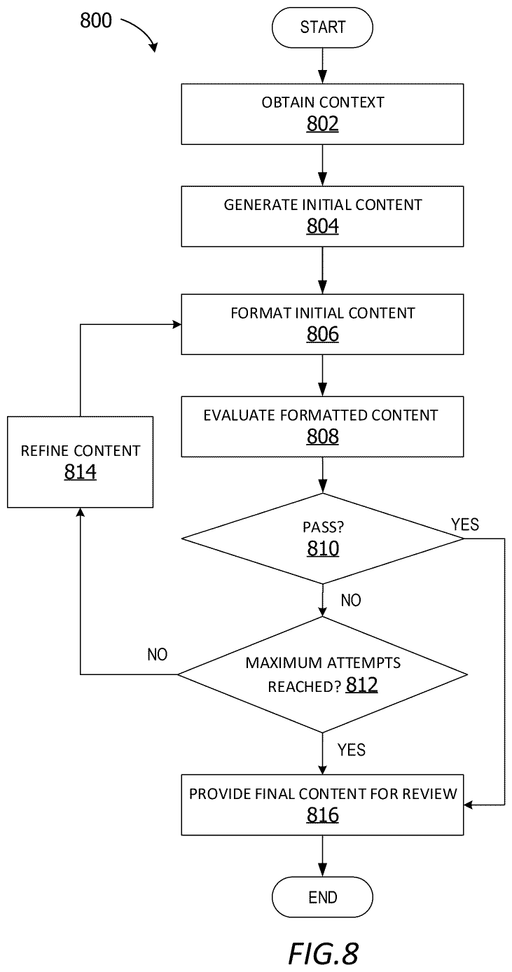

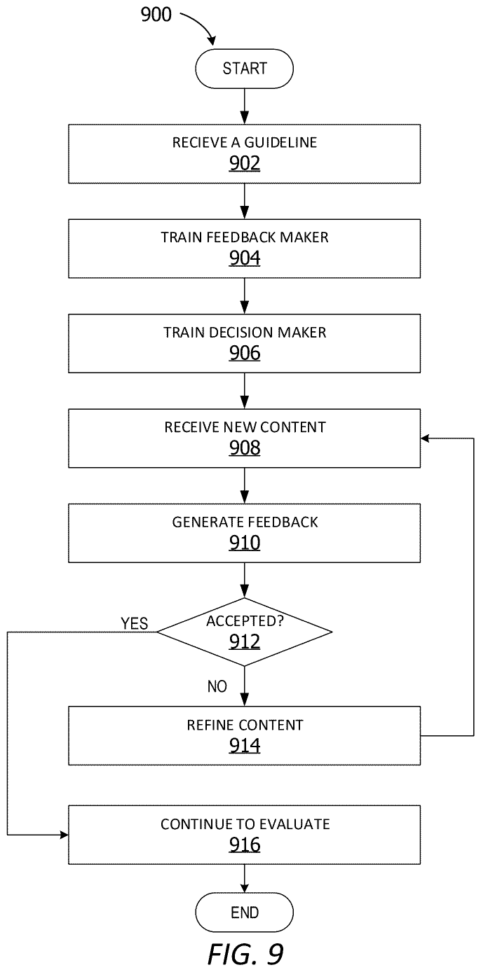

The processor 106 includes any quantity of processing units and is programmed to execute the computer-executable instructions 104. The computer-executable instructions 104 are performed by the processor 106, performed by multiple processors within the computing device 102 or performed by a processor external to the computing device 102. In some examples, the processor 106 is programmed to execute instructions such as those illustrated in the figures (e.g., FIG. 8 and FIG. 9) flow charts.

The computing device 102 further has one or more computer-readable media such as the memory 108. The memory 108 includes any quantity of media associated with or accessible by the computing device 102. The memory 108 in these examples is internal to the computing device 102 (as shown in FIG. 1). In other examples, the memory 108 is external to the computing device (not shown) or both (not shown). The memory 108 can include read-only memory and/or memory wired into an analog computing device.

The memory 108 stores data, such as one or more applications. The applications, when executed by the processor 106, operate to perform functionality on the computing device 102. The applications can communicate with counterpart applications or services such as web services accessible via a network 112. In an example, the applications represent downloaded client-side applications that correspond to server-side services executing in a cloud.

In other examples, the user interface 110 includes a graphics card for displaying data to the user and receiving data from the user. The user interface 110 can also include computer-executable instructions (e.g., a driver) for operating the graphics card. Further, the user interface 110 can include a display (e.g., a touch screen display or natural user interface) and/or computer-executable instructions (e.g., a driver) for operating the display. The user interface 110 can also include one or more of the following to provide data to the user or receive data from the user: speakers, a sound card, a camera, a microphone, a vibration motor, one or more accelerometers, a BLUETOOTH® brand communication module, wireless broadband communication (LTE) module, global positioning system (GPS) hardware, and a photoreceptive light sensor. In a non-limiting example, the user inputs commands or manipulates data by moving the computing device 102 in one or more ways.

The network 112 is implemented by one or more physical network components, such as, but without limitation, routers, switches, network interface cards (NICs), and other network devices. The network 112 is any type of network for enabling communications with remote computing devices, such as, but not limited to, a local area network (LAN), a subnet, a wide area network (WAN), a wireless (Wi-Fi) network, or any other type of network. In this example, the network 112 is a WAN, such as the Internet. However, in other examples, the network 112 is a local or private LAN.

In some examples, the system 100 optionally includes a communications interface device 114. The communications interface device 114 includes a network interface card and/or computer-executable instructions 170 (e.g., a driver) for operating the network interface card. Communication between the computing device 102 and other devices, such as but not limited to a user device 116 and/or a cloud server 118, can occur using any protocol or mechanism over any wired or wireless connection. In some examples, the communications interface device 114 is operable with short range communication technologies such as by using near-field communication (NFC) tags.

The user device 116 represents any device executing computer-executable instructions. The user device 116 can be implemented as a mobile computing device, such as, but not limited to, a wearable computing device, a mobile telephone, laptop, tablet, computing pad, netbook, gaming device, and/or any other portable device. The user device 116 includes at least one processor and a memory. The user device 116 can also include a user interface device.

The cloud server 118 is a logical server providing services to the computing device 102 or other clients, such as, but not limited to, the user device 116. The cloud server 118 is hosted and/or delivered via the network 112. In some non-limiting examples, the cloud server 118 is associated with one or more physical servers in one or more data centers. In other examples, the cloud server 118 is associated with a distributed network of servers.

The system 100 can optionally include a data storage device 128 for storing data, such as, but not limited to approved content 154, past examples 156, and constraints 158. In some embodiments, the approved content 154 includes content that has been approved by internal organizations implementing system 100, such as a policy-making group or public relations department, for example. In some embodiments, the approved content 154 includes one or more approved content items, mappings to attributes of contexts of tasks, mappings to cohorts of users, and/or mappings of the content to topics (including promotions, events, seasons, holidays, etc.). More specifically, the approved content 154 is stored according to attributes of contexts provided for the task, along with other metadata obtained during the review process. In some examples, the approved content 154 is mapped to specific topics and/or events.

In some embodiments, the user device 116 is a mobile device or a personal device used by a customer. The approved content 154 is displayed on or presented to a display of the user device 116 as the user browses or interacts with a website or an application on the user device 116. More specifically, the approved content 154 is presented on a graphic user interface element, such as a website banner, on a website presented on the display of the user device 116. In some embodiments, each user is mapped to a cohort. A cohort refers to a group of users with shared characteristics, a group of users with a common interest or preference, and/or a group of users with similar behaviors. For example, cohorts include, but are not limited to, a group of users with the same subscriptions, a group of users with families, a group of users with pets, a group of users who share similar interests (e.g., fitness, health, craft, art, etc.). These cohort characteristics are determined based on the user's past behaviors, including online and offline behaviors. The online behaviors include the user's browsing behaviors and engagement behaviors. The approved content 154 is displayed on the user device 116 according to the cohorts, such that each user can see online content tailored to their persona, profile, experience, or preference associated with their assigned cohorts. Probabilistic predictions can be used to determine the best content from the approved content 154 to display for each user cohort at any given time. In some embodiments, a user is logged into his/her account to view the online content tailored to the assigned cohort. In some other embodiments, a user is not necessarily logged into his/her account to view the content. In some embodiments, the approved content 154 is dynamically presented to a user as a banner via user interface 120 of the user device 116 based on the user's preference as the user browses or interacts with a website or an application. Based on the user's interaction with a banner, a similar content from the approved content 154 is dynamically selected and displayed. In some embodiments, the approved content 154 that receives more interactions from the users is displayed more often. Additionally, or alternatively, for deterministic contents in the approved content 154, both the aggregate engagement data and the predefined attributes of the deterministic contents are utilized to decide which content to display. By leveraging both of the fixed nature of the content and the collective interactions with the content, the content selection can be optimized to choose both relevant and engaging content for the users.

The approved content 154 is dynamically presented on a website or an application via user interface 120. For example, the approved content 154 is dynamically presented using the dynamic impression allocation of Multi-Armed Bandit (MAB) algorithm, which enables efficient distribution of content across different options. The combination of the dynamic impression allocation and automatic text generation with self-refinement produces content that may outperform traditionally generated content in terms of click-through rates. MAB algorithm, along with variations of MAB algorithm, can be used for different scenarios and be tailored to more customized and personalized content placement.

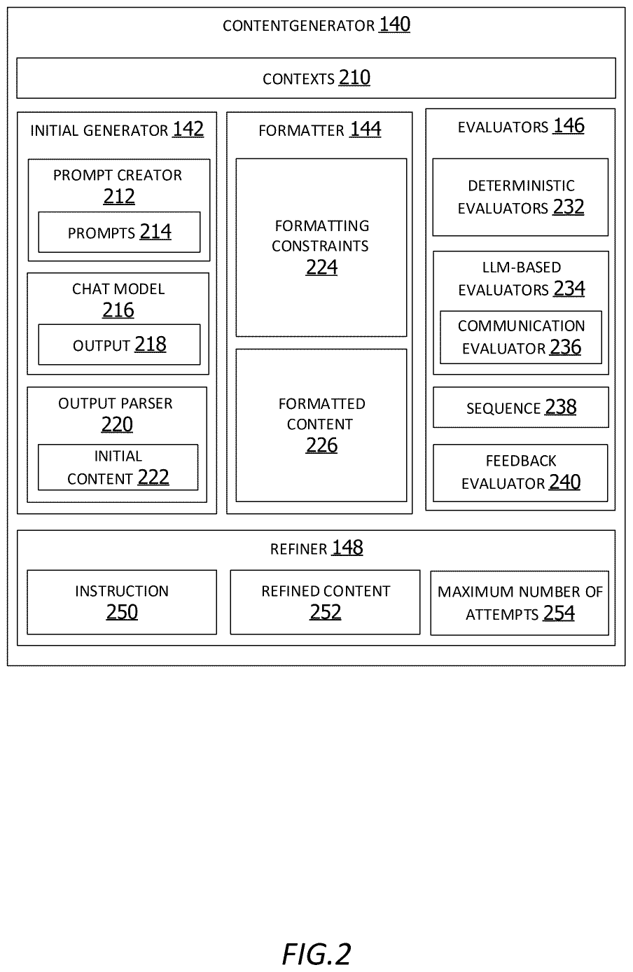

In some embodiments, the past examples 156 include previously generated texts, past tasks, past use cases, and/or past feedback. The data storage device 128 includes a database of pre-generated constraints 158 for creating prompts. The prompt creator may query and retrieve relevant constraints based on given contexts. The prompt creator component is described in more detail with reference to FIG. 2.

The data storage device 128 can include one or more different types of data storage devices, such as, for example, one or more rotating disks drives, one or more solid state drives (SSDs), and/or any other type of data storage device. The data storage device 128 in some non-limiting examples includes a redundant array of independent disks (RAID) array. In some non-limiting examples, the data storage device(s) provide a shared data store accessible by two or more hosts in a cluster. For example, the data storage device may include a hard disk, a redundant array of independent disks (RAID), a flash memory drive, a storage area network (SAN), or other data storage device. In other examples, the data storage device 128 includes a database.

The data storage device 128 in this example is included within the computing device 102, attached to the computing device, plugged into the computing device, or otherwise associated with the computing device 102. In other examples, the data storage device 128 includes a remote data storage accessed by the computing device via the network 112, such as a remote data storage device, a data storage in a remote data center, or a cloud storage. In some embodiments, the cloud server 118 stores data similar to the data stored in the data storage device, such as approved content 154, past examples 156, and/or constraints 158. In some embodiments, multiple cloud server may be employed to store different types of data.

The memory 108 in some embodiments stores one or more computer-executable components. The content generator 140, when executed by the processor 106 of the computing device 102, generates and iteratively evaluates and refines generated content. The user provides the contexts to the content generator 140 via the network 112, via the user interface 110, or via the communications interface device 114. The content generator 140 obtains contexts, which include instructions and guidelines for a content generation task, and generates content according to the contexts. In some examples, the content generator 140 includes the initial generator 142, formatter 144, evaluators 146, and refiner 148. The content generator 140 is described in more details in reference to FIG. 2.

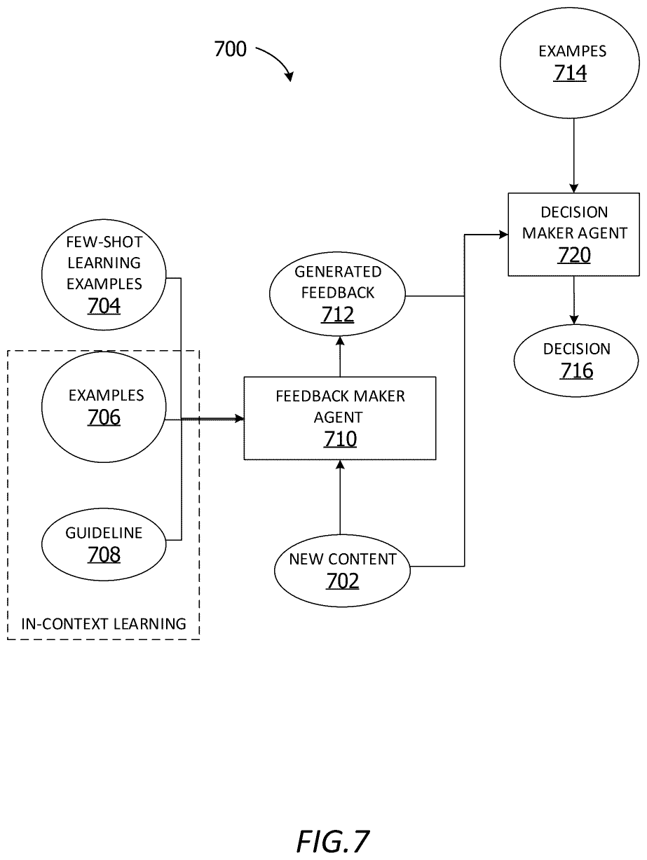

The contents generated from the content generator 140 are presented to a reviewer via the user interface 110. In some embodiments, the reviewer provides feedback and/or guideline via the user interface 110. For each generated content, the reviewer provides decision indicating whether the generated text is approved (accepted) or rejected for use. In some embodiments, the decision with feedback and the guideline are incorporated into a feedback evaluator of the evaluators 146. More details of the feed evaluator are described in reference to FIG. 7 and FIG. 9.

FIG. 2. is an example arrangement illustrating the content generator 140 for automatically generating content with iterative self-refinement. The content generator 140 generates content for a specific task based on the contexts 210. The contexts 210 include information provided about the specific task. The contexts 210 include instructions, specific rules, and conditions that LLM-based generator must adhere to in performing the task. In some embodiments, the contexts 210 are provided as unformatted documents and instructions. The contexts 210 include user context and copy context. The user context includes information about the target audience, such as user persona, user profile, preference of the user, subscription of the user, etc. The content context includes information about the content and/or its structure, such as, but not limited to, syntactic, semantic, lexical, structural, and subjective requirements for the content. Each and every component of the content generator 140 has access to the context 210, including the initial generator 142, the formatter 144, the evaluators 146, and the refiner 148. Based on the contexts 210, a set of constraints are determined to generate the prompts 214. The set of constraints and the prompts 214 are described in more detail in reference to the prompt creator 212.

The content generator 140 includes the initial generator 142, the formatter 144, the evaluators 146, and the refiner 148. The initial generator 142 generates initial content, such as initial content 222, for each specific task, based on the given contexts 210. The initial generator 142 includes a LLM-based generator, such as the chat model 216. In some embodiments, the initial generator 142 generates the initial content 222 in batches. The initial content 222 can be generated in batches to enhance the variety and diversity among the generated contents. For example, if a task requires generating one thousand texts, the initial generator 142 will produce the thousand texts in batches of twenty to thirty texts at a time. Generating content one at a time could result in significant similarities between consecutive texts. In order to prevent substantial similarity and provide diversity among the generated contents, the initial content 222 is generated in batches. For example, if the batch size is M, the generated prompt 214 includes an instruction to generate M different contents. However, if the batch size is 1 (generating content one at a time), the first generated content may be significantly similar to the subsequently generated contents.

Each content generation task has specific contexts, such as the contexts 210. The contexts 210 for a content generation task is provided to the content generator 140. The context 210 is accessible to every component of the content generator 140, including the initial generator 142, the formatter 144, evaluator 146, and the refiner 148. In some embodiments, the content generator 140 obtains the contexts 210 from a user via the network 112, via the user interface 110, or via the communications interface device 114. Once the contexts 210 is obtained, a chain of content generation for the initial generator 142 is invoked. The chain includes generating a prompt using prompt creator 212, generating content using chat model 216, and parsing the generated content using output parser 220.

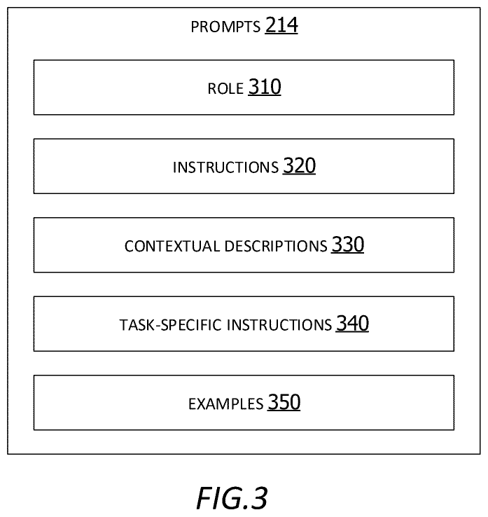

The prompt creator 212 creates a set of prompts 214 to be provided to the chat model 216. In some embodiments, the prompt creator 212 is a LLM-based model, which creates prompts based on given unformatted documents and instructions in the context 210. The LLM-based prompt creator 212 analyzes the contexts 210 and extracts attributes in the contexts 210. The prompt creator 212 generates the prompts 214 based on the attributes in the contexts 210. In some other embodiments, the prompt creator 212 is a template with a set of fields, where each field is a placeholder for specific term(s) or instructions that will be filled based on the contexts 210. The prompt creator 212 interprets the contexts 210 and fill a set of fields contextually to generate the set of prompts 214. The set of prompts 214 provides guidance and instructions based on the given contexts 210 to the chat model 216 such that the chat model 216 can generate output 218 (which will be parsed into the initial content 222) according to the contexts 210. The prompts 214 enables the chat model 216 to maintain consistency and meet the requirements of the task according to the contexts 210. The fields of the set of prompts 214 are illustrated in FIG. 3.

In some embodiments, the prompt creator 212 enables contextual retrieval of a set of constraints for the specific context, such as the contexts 210, and automatically generates the prompts 214 from the retrieved constraints. The set of constraints are a set of individual rules and/or conditions for the attributes specified in the contexts 210 in a structured format. Each content generation task has its own contexts (contexts 210), which includes attributes specifying the quantity and requirements of constraints. This specification of constraints can vary significantly from one task to another. The specifications and the number of constraints needed are tailored to meet the requirements and/or guidelines indicated in the contexts 210 of each task, such that the generated contents can adhere to the requirements. Since the contexts 210 differs for each content generation task, the set of required constraints also varies. The set of constraints applicable to certain tasks may not apply to others. Additionally, some constraints have varying requirements or values depending on the specific contexts for the task.

After the contexts 210 are obtained, the prompt creator 212 invokes a retrieval process to query and receive a correct set of constraints from a pool of constraints (e.g., constraints 158 stored in the data storage device 128) for the contexts 210. In some embodiments, multiple constraints are pre-generated and mapped to the relevant attributes that can be found in the contexts (e.g., contexts 210). The stored constraints 158 are stored as key-value pairs, where the attributes specified in the contexts 210 are used as keys and the pre-generated constraints as values. Based on the attributes of the contexts 210, the correct set of constraints is retrieved from the data store (e.g., from constraints 158 in the data storage device 128). Using the contextually retrieved constraints, the prompt creator 212 automatically fills fields of the set of prompts 214. As more content generation tasks are performed, the contexts 210 and constraints of these tasks accumulate over time. The collection of attribute-constraint pairs over time may enhance the efficiency of prompt creation, allowing for quick look-up to fill the fields of the prompts 214.

The examples of constraints are presented in Table 1.

TABLE 1
Examples of Constraints

| S. No. | Constraints type | constraint |
|---|---|---|
| 1 | Length | Should be less than [N] characters |
| 2 | Topic inclusion | Should mention about [service name] |
| 3 | Topic exclusion | Should not contain info that is also present in [call to action] |
| 4 | Tone of voice | Tone of copy should be: [tone keywords and their |
| | | description] |
| 5 | Style | Style of copy should be: [style]. e.g., assertive, question- |
| | | answer |
| 6 | Keyword inclusion | Should contain the keywords: [list of keywords] |
| 7 | Keyword exclusion | Should not contain these off-brand words: [list of off-brand |
| | | words] |
| 8 | Punctuation | No punctuation after the following words: [word list] |
| 9 | Lexical ordering | Prefer the term [A] instead of [B]. |
| 10 | Coherence | Header and subheader should form a coherent message. |
| 11 | Start with/ End with | Should start with [word/term] OR end with [word/term] |
| 12 | Case | Should be in [Title/Sentence/etc.] case |

After the generation and approval process, the approved contents (e.g., approved content 154) is stored in a data store (e.g., data storage device 128) according to attributes of the contexts 210, along with metadata obtained during review processes. The attributes of the contexts 210 and metadata together can implicitly create unique mappings from the approved content 154 to the constraints.

In some embodiments, the prompt creator 212 is enabled to look up the past tasks and retrieve the relevant constraints based on the given contexts 210, using similarity-based retrieval. The constraints and generated contents are embedded into a semantic-based embedding space and represented by collection of numbers or vectors. The similarity-based retrieval performs similarity metrics, such as cosine similarity, Euclidean distance, dot product, or any other similarity metric that operates on the collection of numbers, to retrieve the closest constraints. The retrieval process can be optimized using techniques like Approximate Nearest Neighbor (ANN) search to handle large-scale datasets efficiently.

In some embodiments, the prompt creator 212 includes relevant examples or past tasks as examples for in-context learning for the chat model 216. For example, the prompt creator 212 may retrieve examples from the past examples 156 to use as examples in the prompts 214. Retrieving examples may be useful in enhancing the quality of content generation because the chat model 216 can learn from the examples included in the prompts 214 to understand the task better and generate more accurate and relevant contents. The prompts 214 are described in more details in reference to FIG. 3.

The chat model 216 is a language model, a large language model (LLM), or a combination of multiple language models, that generates the output 218 according to the set of prompts 214. The chat model 216 is any type of language model, such as, but not limited to, a transformer-based model, sequence to sequence (Seq2Seq) models, and/or a hybrid model. For example, the chat model 216 may include GPT 4, GPT 3.5 Turbo, GPT 4 Omni, and/or any other type of transformer-based language models.

In some embodiments, the chat model 216 is trained using in-context learning (ICL) to learn from past tasks. For example, the chat model 216 learns from specific examples or past tasks included within the prompt 214. This may allow the pre-trained chat model 216 to address new tasks without the need for additional fine-tuning. ICL may enable the chat model 216 to adapt to a wide range of tasks by simply changing the prompt 214. Additionally, as ICL does not require fine-tuning, it can save time and computational resources. The chat model 216 can quickly switch between different content generation tasks without extensive retraining. The performance of the chat model 216 may improve because having the specific examples within the prompts 214 can enhance the understanding and performance of the chat model 216 on new tasks. The contextual information provided in the prompts 214 helps the chat model 216 generate more accurate and relevant texts.

The chat model 216 generates the output 218. In some embodiments, the output 218 is an unparsed single content containing multiple contents for a batch. After the output 218 is generated from the chat model 216, the output parser 220 parses the output 218 into initial content 222. The output parser 220 splits the output 218 into individual contents, such as initial content 222. In some embodiments, the output parser 220 parses and/or coerces the output 218 into different data structures depending on the context (e.g., contexts 210). In some embodiments, the output parser 220 splits the output 218 into the initial content 222, where each content of the initial content 222 has a specified structure and format. For example, the initial content 222 has structures such as, but not limited to, headline only, header and sub-header, header, and multiple descriptions, etc. In some embodiments, the output parser 220 employs a software framework to transform the output 218 into more structured and usable formats that are consumable in the next steps. For example, the output parser 220 may convert the output 218 into structured formats such as JSON, XML, CSV, etc. In some embodiments, the output parser 220 utilizes an existing framework, such as LangChain. Other frameworks can be utilized by the output parser 220, such as, but not limited to DSPy, Guidance, etc. In some embodiments, the output parser 220 includes format instructions, which can enable the initial content 222 to adhere to a specified schema to maintain formatting consistency.

The formatter 144 receives the initial content 222 and applies rule-based formatting constraints 224 to one initial content 222 at a time. The formatter 144 can revise each of the generated initial content 222 to adhere to the specified format indicated in the formatting constraints 224. In some embodiments, the formatting constraints 224 are selected from the constraints that are used to create the prompts 214. In some embodiments, the formatting constraints 224 are simple rule-based formatting constraints. The formatting constraints 224 may vary based on the contexts 210 and/or any other guidelines given to the content generator 140. For example, the formatting constraints 224 includes capitalization, removing periods and/or exclamation points from the header and/or sub-header, removing serial commas, changing “and” to “&,” etc.

After formatting, the formatted content 226 is provided by the formatter 144 to the sequence of evaluators 146. Each evaluator of the sequence of evaluators 146 evaluates the formatted content 226 based on the given contexts 210. The evaluators 146 have access to the contexts 210, and the evaluators 146 determines which evaluators to use and the sequence 238 based on the attributes in the contexts 210. In some embodiments, based on the given contexts 210, relevant evaluators are queried and fetched to form the sequence of evaluators 146. The sequence of evaluators 146 tests one formatted content 226 at a time.

The sequence of evaluators 146 may include a plurality of evaluators, including a plurality of deterministic evaluators 232, a plurality of LLM-based evaluators 234, and/or feedback evaluator 240. The plurality of deterministic evaluators 232 assess deterministic constraints, such as length of the content (character limits), punctuations, off-brand words, jargons, sentence fragments, fact checking, etc. The LLM-based evaluators 234 evaluate more nuanced and subjective aspects of the content such as tone-of-voice, persona, and/or sentiments.

In some embodiments, the LLM-based evaluators 234 includes a communication evaluator 236. The communication evaluator 236 assesses the overall sentiment of generated content. More specifically, the sentiment indicates the way in which a message is communicated, encompassing the choice of words, style, and emotional undertone. The sentiment may significantly influence how the content is perceived by the users. The communication evaluator 236 analyzes a combination of word choice, sentence structure, emotional undertone, and other factors to identify the accurate tone of voice of the content. In some embodiments, the communication evaluator 236 identifies hyperbolic terms that affect the overall sentiment. The sentiment of content is identified as underlying tones such as, but not limited to, “conversational,” “confident,” “captivating,” “exaggerated (hyperbolic term),” or “down-to-earth.”

The sequence 238 is determined based on the contexts 210. In some embodiments, the sequence 238 intermixes the order of the deterministic evaluators 232 and the LLM-based evaluators 234. In some embodiments, some deterministic evaluators 232 are placed in the beginning of the sequence 238, whereas more nuanced LLM-based evaluators are placed later in the sequence 238. For each generation task, the sequence 238 is mapped differently based on the contexts 210.

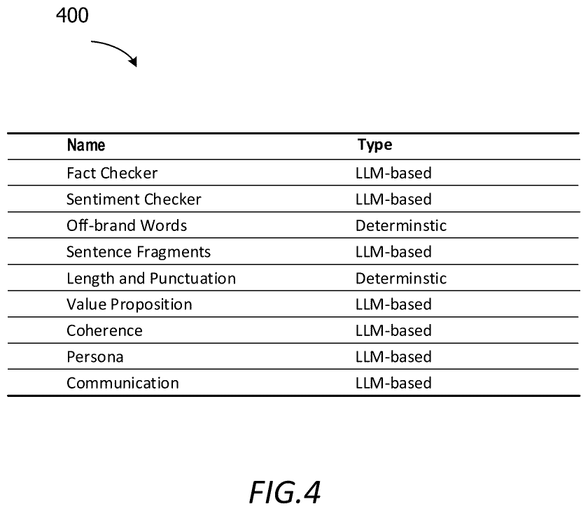

Some evaluators of the sequence of the evaluators 146 grade each component of the formatted content 226 separately. Some evaluators split the formatted content 226 into multiple components or substrings and grade each component separately. For example, a length-checking evaluator splits the formatted content 226 into multiple components and applies different character limits to each component (e.g., header and subheader). Some evaluators of the sequence of the evaluators 146 combine substrings (components) of the formatted content 226 and evaluate the formatted content 226 as a whole. For example, a value proposition checker and/or coherence checker grade the formatted content 226 as a whole. The number of components in the content is determined based on the contexts 210. Based on this determined number of components, each evaluator of the evaluators 146 is designed to assess the components either jointly or separately. Examples of the evaluators in the sequence of the evaluators 146 are explained in more details in reference to FIG. 4.

Each evaluator of the evaluators 146 is associated with a unique identifier. Each evaluator of the evaluators 146 outputs a binary decision (e.g., pass or fail, reject or accept, etc.). Some evaluators of the evaluators 146, in particular, the LLM-based evaluators 234, also output an explanation along with the decision. The decision, explanation, and the unique identifier are passed to the refiner 148 to form an instruction (e.g., instruction 250) for the refiner 148.

In some embodiments, the LLM-based evaluators 234 incorporate Chain-of-Thought (CoT) prompting. Using the chain-of-thought prompting, the LLM-based evaluators employ a step-by-step process to evaluate a content and incorporate each intermediate step in the evaluation process. The LLM-based evaluators 234 are trained to articulate the reasoning process step-by-step. By training using CoT prompting, the ability to handle complex tasks may be improved. To train the LLM-based evaluators 234 using CoT prompting, a plurality of training data sets is generated from examples that demonstrate the step-by-step reasoning process. Each training data set may include input, chain-of-thought reasoning, and output. After training with a few training data set, the LLM-based evaluators 234 are able to provide reasoning and output for a new input.

In some embodiments, the LLM-based evaluators 234 are trained using few-shot learning techniques to recognize patterns, with past tasks and past example content as training data. This way, the LLM-based evaluators 234 are trained more efficiently and cost-effectively compared to the conventional training methods of LLMs. A prompt containing a few examples as training data is provided to the LLM-based evaluators 234 for training. The LLM-based evaluators 234 receive the prompt and use examples to infer the pattern or logic required to complete the evaluation. The LLM-based evaluators 234 apply the inferred pattern or logic to evaluate the content.

The sequence of the evaluators 146 evaluates the formatted content 226 according to the order indicated in the pre-determined sequence 238. When one of the evaluators 146 determines that the formatted content 226 fails the evaluation, the evaluating phase pauses. The decision of the evaluator that failed the formatted content 226 is received by the refiner 148 and translated to an actionable instruction (e.g., instruction 250). In some embodiments, the refiner 148 generates its own instruction 250 using the output of the evaluators 146. The instruction 250 includes clear and specific requirements on how to revise the formatted content 226. The refiner 148 is prompted with the instruction 250. Based on the instruction 250, the refiner 148 generates a refined content 252.

In some embodiments, the instruction (e.g., instruction 250) for the refiner 148 includes output from the communication evaluator 236. For example, when the communication evaluator 236 identifies words that cause the tone of the content to diverge from the intended tone or sentiment for the content in the given contexts 210, the communication evaluator outputs the identified words in the explanation, which states why the identified tone is not suitable for the given contexts 210. The instruction 250 is generated to replace the identified words with new words that are more aligned with the intended tone. The examples are not limited to changing words, but also include changing the sentence structure, style, or any other way that affects the sentiment of the content.

The refined content 252 goes back to the formatter 144 to be re-formatted and are re-evaluated by the sequence of evaluators 146. The refined content 252 undergoes a recursive loop of formatting, evaluation, refinement. This process continues until either it successfully passes through all evaluators of the sequence of the evaluators 146 without failure, or the maximum number of refine attempts 254 is reached.

The refined content 252 goes back to the formatter 144 to be re-formatted to adhere to the required formatting constraints 224. For example, the refiner 148 may change a part of the formatted content 226 during the refinement process and the refined content 252 may not adhere to the required format.

In some embodiments, the refiner is a LLM. In some embodiments, the refiner 148 is the same LLM that is employed to generate the initial content 222 (e.g., chat model 216). In some other embodiments, the refiner 148 is a different LLM. The refinement process is different from the initial generation process, because the refiner 148 only focuses on editing one content at a time according to the instruction 250, which is generated based on the output of the evaluators 146.

The sequence of evaluators 146 assess one content at a time, but multiple contents may go through the loop of the sequence of evaluators 146 and the refiner 148 in parallel. The result of evaluation of one content does not affect the result of evaluation of other contents. Each content undergoes the sequential evaluations by the sequence of evaluators 146, but the evaluation-refinement loop can be run in parallel for multiple contents.

The refined content 252 that undergoes the evaluation process by the sequence of evaluators 146 successfully is provided to reviewers. Typically, to mitigate potential legal risks and to assess whether the generated content adheres to the industry standards, ethical standards, and internal policies, various internal organizations, such as the legal department, marketing department, and/or creative team, can review and approve the content before the refined content 252 is stored as “ready-to-use” content. In addition to legal, marketing, and creative teams, product managers, sales team, compliance officers, and/or customer support team may review the content. The reviewing department may accept, accept with slight modification, or reject the content based on a set of criteria or standards. These decisions are stored with accompanying feedback and can be used to improve the functions of the evaluators 146. In some embodiments, rejected contents are also stored with the feedback to train and improve the evaluators 146.

During the review process, based on the approval and feedback obtained, metadata is generated and stored with the approved content (e.g., approved content 154), along with attributes of the contexts 210. For example, the feedback from the reviewing departments is stored as metadata. The metadata can be added to the approved content as needed. This may improve searchability and contextual understanding of the generated contents, making the content easily accessible and useful for various purposes. Table 2 below illustrates an example of an approved advertisement copy for a free delivery promotion stored according to attributes of the contexts 210, along with the metadata obtained during the review process.

TABLE 2
Example of an approved content with metadata

| | |
|---|---|
| Generated Content | Free delivery from your store |
| | Get groceries & more as soon as today! |
| | $35 min. Terms apply |
| Approved Content with | {“topic”: “free delivery”, |
| metadata | “placement”: “name of use case” |
| | “audience”: “member”, |
| | “persona”: null, |
| | “header”: “Free delivery from your store”, |
| | “subheader”: “Get groceries & more as soon as |
| | today!”, |
| | “disclaimer”: “$35 min. Terms apply.”, |
| | “h_len”: 29, |
| | “sub_len”: 38. |
| | “copy_approved”: “Yes”, |
| | “copy_reason”: null, |
| | “additional_copy_notes”: null, |
| | “marketing_approved”: “Yes”, |
| | “marketing_reason”: null} |

Often, it is not feasible to enumerate all review criteria in advance. The criteria can be numerous and varied, depending on each internal department's specific needs and requirements of the review. Additionally, these review criteria are subject to change over time due to shifts in internal policies, such as priorities or procedural updates, as well as external factors like regulatory changes or industry standards. Accordingly, it may be very difficult to incorporate the review criteria into the LLM generator and evaluators during the generation phase.

In some embodiments, the feedback evaluator 240 is used to automatically apply the feedback and guidelines received from the reviewers to the generated content (e.g., formatted content 226). In some embodiments, the feedback evaluator 240 may include LLMs that are trained using few-shot learning. More details about the feedback evaluator are described in reference to FIG. 7 and FIG. 9.

FIG. 3. is a table illustrating the prompts 214 that is provided to LLM generator. In some embodiments, the prompts 214 consist of a plurality of fields that are filled contextually based on the contexts 210. The role field 310 of the prompts 214 designates the chat model 216 as a creative writer and sets the high-level objective of the task. The instructions 320 provides concise instructions using the provided contexts 210. The contextual descriptions 330 supply context-specific information, such as a topic description or a target audience description. The task-specific instructions 340 includes specific requirements of the task. The examples 350 are provided for in-context learning for the chat model 216 when available. The examples 350 may be obtained from the past examples 156.

For example, the contexts 210 for a particular task for advertisement copy generation for a free delivery promotion is obtained as below.
context={‘topic’: “free delivery”, ‘placement’: “name of use case”, ‘audience’: “nonmember”, ‘persona’=None}

The prompts 214 are filled based on the obtained contexts 210. The role field 310 states “You are a creative advertising writer. Your task is to generate marketing copy using the instructions defined below.” The instructions 320 includes constraints similar to the constraints described in Table 1, with further specification, if required by the contexts 210. The contextual descriptions 330 include descriptions of free delivery and the value proposition associated with the free delivery. The prompts 214 may also include examples 350 of advertisement copies related to free delivery promotion for in-context learning.

FIG. 4 is a table 400 illustrating examples of evaluators of the sequence of evaluators 146. In this example, the table 400 includes both deterministic evaluators and the LLM-based evaluators. The sequence of evaluators 146 may contain any combination of the evaluators presented in the table 400, and the types of evaluators in the sequence of evaluators 146 are not limited to the evaluators presented in the table 400. The sequence of evaluators 146 may include other types of evaluators beyond what is listed in the table 400.

The fact checker evaluator is a LLM-based evaluator that checks the content is factually correct. The sentiment checker evaluator is also a LLM-based evaluator that determines whether the content includes any negative or positive sentiment. The Off-brand words evaluator is a deterministic evaluator that determines whether any off-brand word is included in the content. The sentence fragment evaluator is a LLM-based evaluator that checks whether the content contains any sentence fragment. The length and punctuation evaluator is a deterministic evaluator that checks whether the content meets the length requirement and punctuation requirements. The value proposition evaluator is a LLM-based evaluator that determines, based on the given contexts (e.g., contexts 210), whether there are clear value propositions in the content. The coherence evaluator is a LLM-based evaluator that assess coherency among the elements of the content. For example, the coherence evaluator examines whether the header and subheader of the generated content convey coherent messages. The persona evaluator is a LLM-based evaluator that determines the targeted persona of the content aligns with the given context (e.g., contexts 210). The communication evaluator determines the sentiment and tone of the content as described above with reference to FIG. 2.

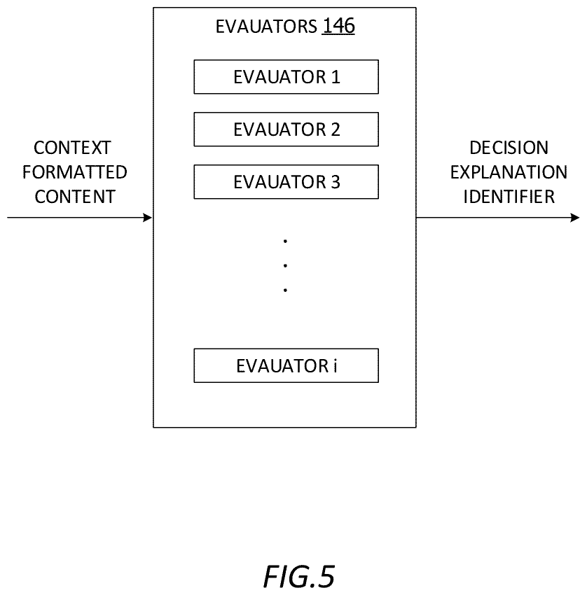

FIG. 5 is an example diagram illustrating operation of the sequence of evaluators 146. The sequence of evaluators 146 is composed of individual evaluators according to a given order (e.g., sequence 238). The context (e.g., contexts 210) and a formatted content (e.g., one of the formatted contents 226) are provided to the sequence of evaluators 146. The evaluators 146 sequentially evaluate the formatted content, according to the pre-determined sequence. When the formatted content fails one of the evaluators, Ei, the sequence of evaluators 146 stops processing the formatted content. The failed evaluator outputs a result, which includes a unique identifier of the failed evaluator, the decision (pass or fail), and/or explanation if applicable. The result is provided to the refiner 148 to generate an actionable instruction (e.g., instruction 250) and the refiner 148 is prompted with the instruction. The refiner 148 revises the content to address the issue that caused the failure, and the revised content goes through the evaluators 146 again.

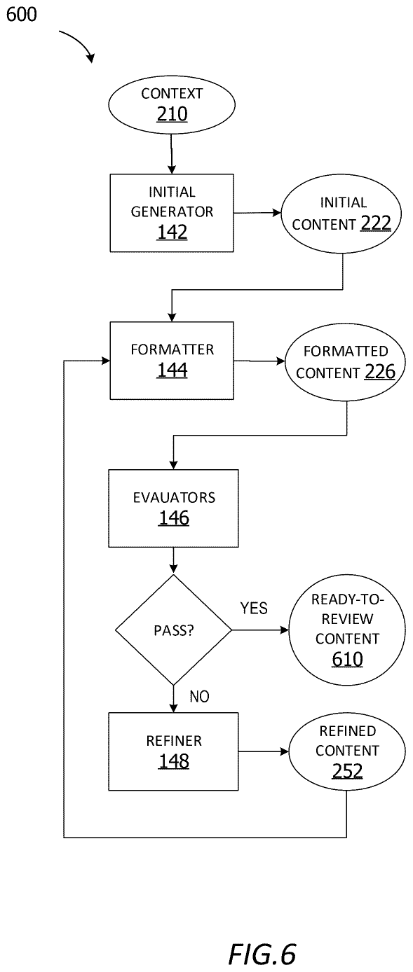

FIG. 6. is a system diagram illustrating process 600 implemented by a computer device, such as computing device 102, to automatically generate content with iterative self-refinement. Contexts 210 is provided to the initial generator 142. The initial generator 142 generates the initial content 222 based on the contexts 210. In some embodiments, the initial generator 142 generates the initial content 222 in batches. In some embodiments, the batch size is pre-determined before the contents are generated. In some other embodiments, the batch size is dynamically determined or adjusted. The initial generator 142 provides the initial content 222 to the formatter 144. The formatter 144 formats the initial content 222 into the formatted content 226 one at a time. The formatted content 226 are sent to the evaluators 146. The evaluators 146 performs a series of evaluations on formatted content 226 according to a pre-determined sequence (e.g., sequence 238). Each evaluator of the evaluators 146 determines whether the formatted content 226 passes the evaluation. If the formatted content 226 fails any one of the evaluators 146, the evaluation stops, and the failing content is sent to the refiner 148. The refiner 148 generates the refined content 252 according to the instruction generated from the result of the evaluators 146. The refined content 252 is sent back to the formatter 144 to be formatted again and undergoes the re-evaluation by the evaluators 146. The recursive loop of evaluation, refinement, and formatting proceeds until the earlier of the content passing all the evaluators 146 or the maximum number of refine attempts 254 is reached.

If the formatted content 226 passes through all the evaluators 146 successfully, the content is provided to the reviewers as ready-to-review content 610.

FIG. 7 is a system diagram illustrating process 700 implemented by a computer device, such as computing device 102, to predict approval of a newly generated content based on previously received feedback and guideline. The feedback evaluator 240 assesses the quality of a generated content according to the feedback and guidelines received from the human reviewers. In some embodiments, the feedback evaluator 240 has two agents, a feedback maker agent 710 and a decision maker agent 720.

The feedback maker agent 710 predicts and generates feedback for each new content 702. In some embodiments, the new content 702 is the formatted content 226. In some embodiments, each guideline 708 from the reviewers has its own feedback maker agent 710. The feedback maker agent 710 is a LLM pre-trained with domain-specific knowledge in advance. In some embodiments, the feedback maker agent 710 is trained using few-shot learning with the few-shot learning examples 704 as task-specific examples. The few-shot learning examples 704 include past content and accompanying feedback that are relevant to the guideline 708. In some embodiments, the feedback maker agent 710 is alternatively or additionally trained using in-context learning, where the given guideline 708 and examples 706 are used as prompts for in-context learning. The examples 706 include previously generated content, both accepted and rejected, with corresponding feedback. After being trained using few-shot learning and/or in-context learning, the feedback maker agent 710 learns to generate or predict feedback 712 for the new content 702. For each new content 702, the feedback maker agent 710 generates the feedback 712 based on the guidelines 708.

The decision maker agent 720 receives the generated feedback 712 for the new content 702 and determines whether the new content 702 is acceptable based on the guideline 708. The decision maker agent 720 is a LLM-based evaluator. In some embodiments, the decision maker agent 720 is trained using examples 714 as training data. The decision maker agent 720 is trained using few-shot learning where examples 714 include past content, their generated feedback from the feedback maker agent 710, the given guideline 708, and the accept/reject decision made on the content in a format of <content, generated feedback, guideline, accept/reject labels>. After being trained using few-shot learning, the decision maker agent 720 can predict whether the new content 702 would be accepted or rejected. The decision maker agent 720 is prompted with the new content 702 and the generated feedback 712 and outputs the decision 716, which indicates whether the new content 702 would be accepted or rejected. If the decision maker agent 720 determines that the new content 702 would be rejected, the new content 702 is provided to the refiner block (e.g., refiner 148) for refinement based on the guideline 708, feedback 712, and decision 716.

In some embodiments, the feedback maker agent 710 and the decision maker agent 720 perform sequentially. For example, the feedback maker agent 710 is called only once to generate the feedback 712. The feedback 712 is provided to the decision maker agent 720 to make the decision 716.

For example, the feedback evaluator 240 can evaluate an advertisement copy generated by an embodiment of this disclosure. Table 3 below illustrates an example operation of how the feedback evaluator 240 decides to accept or reject content. More specifically, Table 3 demonstrates the evaluation of a newly generated and formatted advertisement copy, “Don't miss out: get free shipping with no order minimum.” The feedback maker agent 710 predicts the generated feedback 712 based on the guideline 708. The generated feedback 712 is provided to the decision maker agent 720, and based on the generated feedback 712 being positive, the decision maker agent 720 outputs “accept” as the predicted decision 716.

TABLE 3
Example feedback and decision from the feedback evaluator

| | |
|---|---|
| Generated Content | “Don't miss out: get free shipping with no order minimum” |
| Feedback Maker Agent | The marketing copy effectively and clearly highlights the product's |
| | benefits without overpromising. The tone is relatable and |
| | trustworthy, while the focus on convenience and benefits enhances |
| | customer perception. |
| Decision Maker Agent | Accept |

FIG. 8 is a flow chart illustrating operation of the computing device to automatically generate content using LLM-driven iterative evaluation-refinement techniques. The process 800 shown in FIG. 8 is performed by a constrained content generator, executing on a computer device, such as the computing device 102 in FIG. 1.

The process begins by obtaining context for a generation task at 802. The context may include user context and content context. Based on the provided context, initial content is generated at 804. The initial contents are generated by a constrained content generator including a large language model (LLM), such as, but not limited to, the initial generator 142 in FIG. 1. Generating the initial content may further include creating prompts for a chat model, generating unparsed output by the chat model, and parsing the unparsed output by an output parser. The generated initial content is formatted at 806. Each formatted content is evaluated through a sequence of evaluators at 808. A determination is made at 810 whether the content passes every evaluator of the sequence of evaluators successfully. If the content fails at any point in the sequence of evaluators, a determination is made at 812 whether the maximum number of refine attempts is reached. If the maximum number of refine attempts has not been reached, the content is refined at 814 based on the result from the specific evaluator where the failure occurred. The content goes back to the operation 806 to be re-formatted and re-evaluated at 808. The process iteratively repeats operations 806 through 814 until the content successfully passes every evaluator of the sequence of evaluators or the maximum number of refine attempts is reached. If the determination made at 810 or at 812 is yes, the final content is provided to reviewers for review at 816 and the process terminates thereafter.

FIG. 9 is a flow chart 900 illustrating operation of the computing device to automatically evaluate new content according to a guideline. The process begins by receiving a guideline for generating content from an internal organization at 902. A LLM-based feedback maker agent is trained at 904 using few-shot learning and/or in-context learning with past examples and feedback. A LLM-based decision maker agent is trained at 906 using few-shot learning with decisions in past examples. A new content to be evaluated based on the guideline is received at 908. The trained feedback maker agent generates feedback for the new content at 910. A determination is made at 912 by the trained LLM-based decision maker whether the new content is acceptable based on the guideline. If the content is not acceptable, the content is refined at 914, and the refined content goes back to the feedback maker agent at 908 to be re-evaluated. If the content is accepted, the content is passed to the next evaluator at 916 to be evaluated further. The process terminates thereafter.

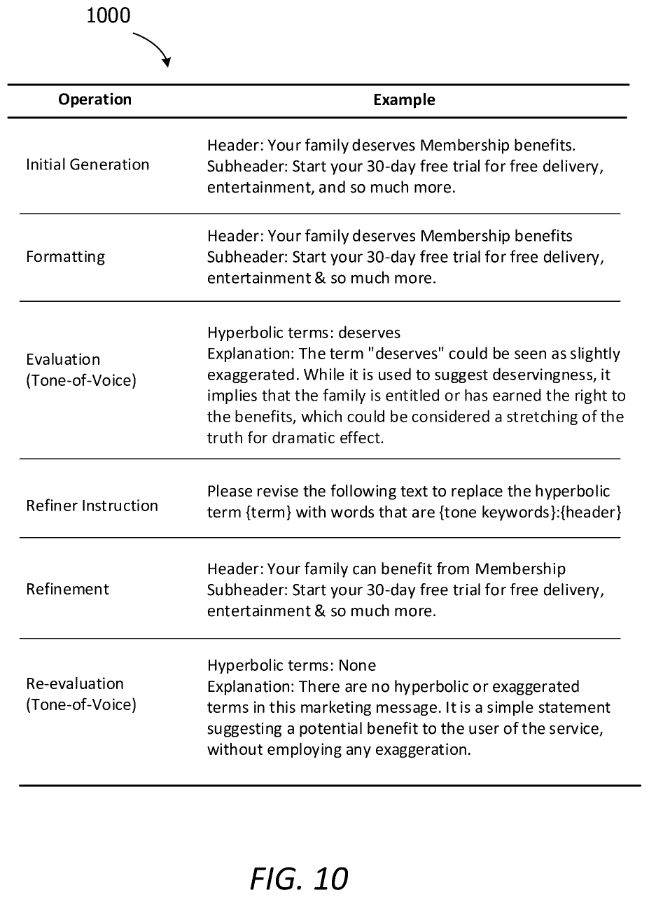

FIG. 10 is a table 1000 illustrating examples of an automatically generated content during the generation, formatting, evaluation, and refinement steps. In this example, the table 1000 is displayed with evaluation results and refinement instruction. In this example, the generated content is an advertisement copy.

After the initial generation, an initial content that consists of header and subheader is generated. The example initial content has header and subheader, but the structure of the content is not limited to a combination of a header and subheader. The initial content is formatted according to formatting constraints. In this example, during formatting, a period is removed from the header, serial commas are removed from the subheader, and “and” is changed to “&.” During the evaluation step, the communication evaluator outputs its decision that the content has failed because hyperbolic terms are detected. The explanation indicates that the term “deserves” is a hyperbolic term and may not be suitable. An instruction for the refiner is created from the output of the evaluator, which prompts the refiner to replace the identified hyperbolic term with words that are aligned with “tone keywords” in the header. During the refinement step, the header is revised to replace the identified hyperbolic term “deserves” with “can benefit.” The refined text undergoes re-formatting (not shown), and the communication evaluator re-evaluated the refined text. The re-evaluation output indicates that there is no hyperbolic term. The refined text passes the re-evaluation and is presented for review.

### ADDITIONAL EXAMPLES

In some embodiments, the system automatically generates adaptive content by recursively self-evaluate and refine the generated content. The system generates a batch of candidate data using a large language model (LLM) based generator, formats the batch of candidate data according to a plurality of formatting constraints. The system recursively evaluates, using a sequence of evaluators, a candidate of the batch of candidate data. When the system determines whether any evaluator of the sequence of evaluators fails the candidate, based on determining that at least one evaluator of the sequence of evaluators fails the text, the system identifies a first failing evaluator of the sequence of evaluators. The system maps an output of the first failing evaluator to a refiner instruction. The system refines, using a LLM based refiner, the candidate based on the refiner instruction, reformats the refined candidate, and re-evaluate, using the sequence of evaluators, the refined candidate, until earlier of either a maximum of refine attempts is reached or all evaluators of the sequence of evaluators are successful.

An example method comprises: generating a batch of candidate data using a large language model (LLM) based generator; formatting the batch of candidate data according to a plurality of formatting constraints; evaluating, using a sequence of evaluators, a candidate of the batch of candidate data; determining whether any evaluator of the sequence of evaluators fails the candidate; based on determining that at least one evaluator of the sequence of evaluators fails the candidate, identifying a first failing evaluator of the sequence of evaluators; mapping an output of the first failing evaluator to a refiner instruction; refining, using a LLM based refiner, the candidate based on the refiner instruction; reformatting the refined candidate; and re-evaluating, using the sequence of evaluators, the refined candidate, until earlier of either a maximum of refine attempts is reached or all evaluators of the sequence of evaluators are successful.

One or more example computer storage devices has computer-executable instructions stored thereon, which, on execution by a computer, cause the computer to perform operations comprising: generating a batch of candidate data using a large language model (LLM) based generator; formatting the batch of candidate data according to a plurality of formatting constraints; evaluating, using a sequence of evaluators, a candidate of the batch of candidate data; determining whether any evaluator of the sequence of evaluators fails the candidate; based on determining that at least one evaluator of the sequence of evaluators fails the candidate, identifying a first failing evaluator of the sequence of evaluators; mapping an output of the first failing evaluator to a refiner instruction; refining, using a LLM based refiner, the candidate based on the refiner instruction; reformatting the refined candidate; and re-evaluating, using the sequence of evaluators, the refined candidate, until earlier of either a maximum of refine attempts is reached or all evaluators of the sequence of evaluators are successful.

Alternatively, or in addition to the other examples described herein, examples include any combination of the following:
wherein the sequence of evaluators comprises at least one deterministic-type evaluator and at least one LLM-based evaluator;
wherein the sequence of evaluators comprises a feedback evaluator, and wherein the feedback evaluator comprises a feedback maker agent and a decision maker agent;
wherein the feedback maker agent is trained using training examples, wherein the training examples comprise past candidate data and accompanying feedback;
wherein the at least one LLM-based evaluator comprises a communication evaluator;
wherein the communication evaluator determines subjective sentiment of a content;
wherein generating the batch of candidate data using the LLM-based generator comprises: obtaining context, automatically creating a prompt based on the context, and prompting the LLM-based generator with the prompt;
wherein automatically creating the prompt based on the context comprises: retrieving a plurality of constraints based on the context;
wherein automatically creating the prompt based on the context comprises: retrieving a plurality of constraints from past tasks based on similarity;
wherein automatically creating the prompt comprises filling a plurality of fields based on the context with the retrieved plurality of constraints;
wherein the context comprises user context and content context;
wherein the context comprises instructions, specific rules, and conditions for generating the batch of candidate data;
wherein the prompt comprises training examples, wherein the LLM-based generator is trained using the training examples;
wherein generating the batch of candidate data using the LLM-based generator further comprises parsing the batch of candidate data into a specific structure;
receive a guideline, generate predicted feedback for the candidate based on the guideline, and based on the predicted feedback, determine whether the candidate is acceptable based on the guideline;
wherein the at least one LLM-based evaluator is trained using chain-of-thoughts prompting;
wherein the at least one LLM-based evaluator learns to evaluate by few-shot learning;
wherein the at least one LLM-based evaluator learns to evaluate by in-context learning;
wherein mapping the output of the first failing evaluator to the refiner instruction comprises transforming a decision and an explanation of the first failing evaluator to the refiner instruction;
wherein each evaluator of the sequence of evaluators is associated with a unique identifier;
wherein each evaluator of the sequence of evaluators outputs a binary decision;
wherein mapping the output of the first failing evaluator to the refiner instruction comprises passing a unique identifier of the first failing evaluator and a decision of the first failing evaluator to the LLM based refiner;
presenting the refined candidate to a reviewer;
receiving feedback from the reviewer, wherein the feedback is used to train the at least one LLM-based evaluator;
storing the refined candidate in a datastore according to cohorts;
displaying the stored candidate dynamically based on the cohorts;
wherein the sequence of evaluators and the LLM based refiner evaluate and refine multiple candidates in parallel;

While the aspects of the disclosure have been described in terms of various examples with their associated operations, a person skilled in the art would appreciate that a combination of operations from any number of different examples is also within scope of the aspects of the disclosure.

At least a portion of the functionality of the various elements in FIG. 1, FIG. 2, FIG. 3, FIG. 4, FIG. 5, FIG. 6, and FIG. 7 can be performed by other elements in FIG. 1, FIG. 2, FIG. 3, FIG. 4, FIG. 5, FIG. 6, and FIG. 7, or an entity (e.g., processor 106, web service, server, application program, computing device, etc.) not shown in FIG. 1, FIG. 2, FIG. 3, FIG. 4, FIG. 5, FIG. 6, and FIG. 7.

In some examples, the operations illustrated in FIG. 8 and FIG. 9 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH®” as used herein refers, in some examples, to a wireless technology standard for exchanging data over short distances using short wavelength radio transmission. The term “NFC” as used herein refers, in some examples, to a short-range high frequency wireless communication technology for the exchange of data over short distances.

While no personally identifiable information is tracked by aspects of the disclosure, examples have been described with reference to data monitored and/or collected from the users. In some examples, notice is provided to the users of the collection of the data (e.g., via a dialog box or preference setting) and users are given the opportunity to give or deny consent for the monitoring and/or collection. The consent can take the form of opt-in consent or opt-out consent.

### Example Operating Environment

Example computer-readable media include flash memory drives, digital versatile discs (DVDs), compact discs (CDs), floppy disks, and tape cassettes. By way of example and not limitation, computer-readable media comprise computer storage media and communication media. Computer storage media include volatile and nonvolatile, removable, and non-removable media implemented in any method or technology for storage of information such as computer-readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Example computer storage media include hard disks, flash drives, and other solid-state memory. In contrast, communication media typically embody computer-readable instructions, data structures, program modules, or the like, in a modulated data signal such as a carrier wave or other transport mechanism and include any information delivery media.

Although described in connection with an example computing system environment, examples of the disclosure are capable of implementation with numerous other special purpose computing system environments, configurations, or devices.

Examples of well-known computing systems, environments, and/or configurations that can be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices can accept input from the user in any way, including from input devices such as a keyboard or pointing device, via gesture input, proximity input (such as by hovering), and/or via voice input.

Examples of the disclosure can be described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform tasks or implement abstract data types. Aspects of the disclosure can be implemented with any number and organization of such components or modules. For example, aspects of the disclosure are not limited to the specific computer-executable instructions, or the specific components or modules illustrated in the figures and described herein. Other examples of the disclosure can include different computer-executable instructions or components having more functionality or less functionality than illustrated and described herein.

In examples involving a general-purpose computer, aspects of the disclosure transform the general-purpose computer into a special-purpose computing device when configured to execute the instructions described herein.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing an operation before, contemporaneously with, or after another operation is within the scope of aspects of the disclosure.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to “A” only (optionally including elements other than “B”); in another embodiment, to B only (optionally including elements other than “A”); in yet another embodiment, to both “A” and “B” (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e., “one or the other but not both”) when preceded by terms of exclusivity, such as “either” “one of’ “only one of’ or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of ‘A’ and ‘B’” (or, equivalently, “at least one of ‘A’ or ‘B’,” or, equivalently “at least one of ‘A’ and/or ‘B’”) can refer, in one embodiment, to at least one, optionally including more than one, “A”, with no “B” present (and optionally including elements other than “B”); in another embodiment, to at least one, optionally including more than one, “B”, with no “A” present (and optionally including elements other than “A”); in yet another embodiment, to at least one, optionally including more than one, “A”, and at least one, optionally including more than one, “B” (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for context-based automated content generation, the system comprising:
a processor; and
a computer-readable medium storing instructions that upon execution cause the processor to:
generate a batch of candidate data using a large language model (LLM) based generator;
format the batch of candidate data according to a plurality of formatting constraints;
evaluate, using a sequence of evaluators, a candidate of the batch of candidate data;
determine whether any evaluator of the sequence of evaluators fails the candidate;
based on determining that at least one evaluator of the sequence of evaluators fails the candidate, identify a first failing evaluator of the sequence of evaluators;
map an output of the first failing evaluator to a refiner instruction;
refine, using a LLM based refiner, the candidate based on the refiner instruction;
reformat the refined candidate; and
re-evaluate, using the sequence of evaluators, the refined candidate, until earlier of either a maximum of refine attempts is reached or all evaluators of the sequence of evaluators are successful.

2. The system of claim 1, wherein the sequence of evaluators comprises at least one deterministic-type evaluator and at least one LLM-based evaluator.

3. The system of claim 2, wherein the at least one LLM-based evaluator comprises a communication evaluator.

4. The system of claim 2, wherein the at least one LLM-based evaluator is trained to evaluate by few-shot learning.

5. The system of claim 1, wherein generating the batch of candidate data using the LLM based generator comprises:
obtaining context;
automatically creating a prompt based on the context; and
prompting the LLM based generator with the prompt.

6. The system of claim 5, wherein the context comprises user context and content context.

7. The system of claim 1, wherein the instructions when executed further cause the processor to:
receive a guideline;
generate predicted feedback for the candidate based on the guideline; and
based on the predicted feedback, determine whether the candidate is acceptable based on the guideline.

8. A method comprising:
generating a batch of candidate data using a large language model (LLM) based generator;
formatting the batch of candidate data according to a plurality of formatting constraints;
evaluating, using a sequence of evaluators, a candidate of the batch of candidate data;
determining whether any evaluator of the sequence of evaluators fails the candidate;
based on determining that at least one evaluator of the sequence of evaluators fails the candidate, identifying a first failing evaluator of the sequence of evaluators;
mapping an output of the first failing evaluator to a refiner instruction;
refining, using a LLM based refiner, the candidate based on the refiner instruction;
reformatting the refined candidate; and
re-evaluating, using the sequence of evaluators, the refined candidate, until earlier of either a maximum of refine attempts is reached or all evaluators of the sequence of evaluators are successful.

9. The method of claim 8, wherein the sequence of evaluators comprises at least one deterministic-type evaluator and at least one LLM-based evaluator.

10. The method of claim 9, wherein the at least one LLM-based evaluator comprises a communication evaluator.

11. The method of claim 9, wherein the at least one LLM-based evaluator is trained to evaluate by few-shot learning.

12. The method of claim 8, wherein generating the batch of candidate data using the LLM based generator comprises:
obtaining context;
automatically creating a prompt based on the context; and
prompting the LLM based generator with the prompt.

13. The method of claim 12, wherein the context comprises user context and content context.

14. The method of claim 8, further comprising:
receiving a guideline;
generating predicted feedback for the candidate based on the guideline; and
based on the predicted feedback, determine whether the candidate is acceptable based on the guideline.

15. One or more computer storage devices having computer-executable instructions stored thereon, which, on execution by a computer, cause the computer to perform operations comprising:
generating a batch of candidate data using a large language model (LLM) based generator;
formatting the batch of candidate data according to a plurality of formatting constraints;
evaluating, using a sequence of evaluators, a candidate of the batch of candidate data;
determining whether any evaluator of the sequence of evaluators fails the candidate;
based on determining that at least one evaluator of the sequence of evaluators fails the candidate, identifying a first failing evaluator of the sequence of evaluators;
mapping an output of the first failing evaluator to a refiner instruction;
refining, using a LLM based refiner, the candidate based on the refiner instruction;
reformatting the refined candidate; and
re-evaluating, using the sequence of evaluators, the refined candidate, until earlier of either a maximum of refine attempts is reached or all evaluators of the sequence of evaluators are successful.

16. The one or more computer storage devices of claim 15, wherein the sequence of evaluators comprises at least one deterministic-type evaluator and at least one LLM-based evaluator.

17. The one or more computer storage devices of claim 16, wherein the at least one LLM-based evaluator comprises a communication evaluator.

18. The one or more computer storage devices of claim 16, wherein the at least one LLM-based evaluator is trained to evaluate by few-shot learning.

19. The one or more computer storage devices of claim 15, wherein generating the batch of candidate data using the LLM based generator comprises:
obtaining context, the context comprising user context and content context;
automatically creating a prompt based on the context; and
prompting the LLM based generator with the prompt.

20. The one or more computer storage devices of claim 15, wherein the operations further comprise:
receiving a guideline;
generating predicted feedback for the candidate based on the guideline; and
based on the predicted feedback, determine whether the candidate is acceptable based on the guideline.
